(19) United States
(12) Patent Application Publication
(10) Pub. No.: US 2004/0164474 A1
(43) Pub. Date: Aug. 26, 2004

(54) Modular fixture system

(76) Inventor: Michael J. Healy, Troy, MI (US)

Correspondence Address: H. Keith Miller, Harness, Dickey & Pierce, P.L.C., P.O. Box 828, Bloomfield Hills, MI, 48303, US

(21) Appl. No.: 10/372,995

(22) Filed: Feb. 24, 2003

(51) Int. Cl. B23Q 3/08

(52) U.S. Cl. 269/32

(57) ABSTRACT

A modular fixture or holding mechanism that includes modular portions to be interconnected according to a plurality of combinations to provide a plurality of positioning orientations. A one of plurality of a first modular portion and one of a plurality of a second modular portion can be selectively positioned relative to one another to provide for a plurality of selected holding positions. Different selected modular portions may be selected to provide different holding positions.

### FIELD OF THE INVENTION

The present invention relates to fixture systems, and particularly to a modular fixture system, including a plurality of modular portions that may be assembled in a plurality of selected configurations.

### BACKGROUND OF THE INVENTION

In a manufacturing process, it is often required to hold a member, structure, or portion of a structure in a selected position. Generally, the member is held in a selected position so that work can be done to the member being held. It is also often required to hold the member in the selected position for a long period of time. Therefore, providing a mechanical system to hold and position the member in the selected position is desired.

The member to be held is often desired to be held in a plurality of selected positions. These selected positions can vary over time and with the particular member to which work is being done. A fixture system that allows for variation of positioning of the member is desirable. Nevertheless, many fixture or positioning systems are highly specialized in design for only one of a multitude of variable positions. As the member to be worked on vary over time, a specifically designed fixture or holder is unable to adapt to the new member. Also, the work done to a selected member may vary over time, therefore requiring a different orientation or position of the member relative to the machine or individual performing the work.

Therefore, it is desirable to provide a fixture mechanism that can be adapted for a variety of differing member, positions of the member, and work to be performed on the member. It is desirable that a fixture be able to be adapted, through movement of various parts or interchangeability of various parts, which can position or move a member to any one of a plurality of selected positions. It is desired that such a fixture be able to provide the desired positioning of the member without replacing the entire fixture. In addition, it is desired to provide a fixture mechanism that can be designed and produced in a limited amount of time to the required specifications.

### SUMMARY OF THE INVENTION

The present invention provides a modular fixture or holding mechanism, which can be oriented and positioned according to a plurality of combinations to provide a plurality of positioning orientations. Generally, the fixture includes at least a first modular portion and a second modular portion. The first modular portion can be fixed to a base or riser. The second modular portion can be held relative to the first modular portion to provide for a selected orientation of holding a member. A plurality of the first modular portions and a plurality of the second modular portions can be selectively positioned relative to one another to provide for a plurality of selected holding positions.

Further areas of applicability of the present invention will become apparent from the detailed description provided hereinafter. It should be understood that the detailed description and various examples, while indicating various embodiments of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is an exploded view of a modular fixture system according to a first embodiment;

FIG. 2 is a front plan view of an assembled modular fixture according to an embodiment of the invention;

FIG. 3a is a front elevational view of a mid-plate according to the invention;

FIG. 3b is a side elevational view of the mid-plate FIG. 3a;

FIG. 4 is a side elevational view of a mid-plate according to the alternative embodiment of the invention;

FIG. 5 is a side elevational view of a mid-plate according to an alternative embodiment of the invention;

FIG. 6 is a side elevational view of a mid-plate according to an additional alternative embodiment of the invention;

FIG. 7 is a side elevational view of a mid-plate according to a further alternative of the present invention;

FIG. 8 is a side elevational view of a mid-plate according to a further alternative embodiment of the present invention;

FIG. 9 is a side elevational view of a mid-plate according to a still further alternative embodiment of the present invention;

FIG. 10 is a side elevational view of a mid-plate according to an alternative embodiment of the invention;

FIG. 11a is a side elevational view of a lower arm according to an embodiment of the present invention;

FIG. 11b is a top elevational view of the lower arm illustrated in FIG. 11a.

FIG. 12a is a side elevational view of a lower arm according to an alternative embodiment of the present invention;

FIG. 12b is a top elevational view of the lower arm of FIG. 12a;

FIG. 13a is a side elevational view of a lower arm according to a further alternative embodiment of the present invention;

FIG. 13b is a top elevational view of the lower arm of FIG. 13a;

FIG. 14a is a side elevational view of a lower arm according to a further alternative embodiment of the present invention;

FIG. 14b is a top elevational view of the lower arm of FIG. 14a;

FIG. 15 is a flow chart of a method of using the present invention according to various embodiments;

FIG. 16 is a detailed view of block 602 of FIG. 15; and

FIG. 17 is a flow chart of a computer program for performing the s??block 604 in FIG. 15.

### DETAILED DESCRIPTION OF VARIOUS EMBODIMENTS

The following description of various embodiments is merely exemplary in nature and is in no way intended to limit the invention, its application, or uses.

With reference to FIG. 1, a modular fixture system 10 according to a various embodiment is illustrated. The fixture system 10 can be provided relative to a surface 12, such that a structure or member (not particularly illustrated) can be held relative the surface 12 or relative to another structure, such as a laser cutter. The additional structure is also positioned relative the surface 12 or mounted to the surface 12. For example, the member being held by the fixture 10 may be worked upon by a laser cutter, which is moving relative to the surface 12.

The fixture 10 includes a riser or mounting member 14. The riser 14 includes a base or foot portion 16 and a rising or upstanding portion 18. The rising portion 18 includes a lower riser portion 20, which is adjacent the foot 16, and an upper riser portion 22, which is adapted to be positioned or fixed with various members. A mid-plate or mounting plate 30 can be positioned relative the riser 14, either directly or through intermediate portions, such as a spacer 32 and a shim 34. The mid-plate 30 may be any member to interconnect the various other portions of the fixture 10 with the riser 14. The spacer 32 or shim 34 can be used to select a desired distance between the upper portion 22 and the mid-plate 30 relative to the riser 14. Therefore, a plurality of spacers 32 or shims 34 can be used to provide a selected distance between the riser 14 and the mid-plate 30.

The upper riser portion 22 includes a plurality of screw holes 36 and peg holes 38 to allow for fixation of the mid-plate 30 relative the riser 14. Similarly, the spacer 32 includes a plurality of bores 40, while the shim 34 includes a plurality of slots 42. Also, the mid-plate 30 includes a plurality of screw or tapped bores 44 and a plurality of smooth or orientation bores 46. The tapped bores 44 receive a screw 48 while the smooth bores 46 receive a peg 50. Therefore, the mid-plate 30 can be positioned relative the riser 14 in a selected orientation by positioning the mid-plate 30 and securing it in place with the pegs 50 and screws 48. For example, the mid-plate 30 may be first positioned relative the riser 14 using the pegs 50. Once a selected position is achieved, the mid-plate 30 can be held in the selected position with the screws 48. Nevertheless, it will be understood that various other mechanisms may be used to position the mid-plate 30 relative the riser 14. For example, rivets, pop rivets, locking pins or cotter pins, may also be used to position the mid-plate 30 relative the riser 14.

The mid-plate 30 includes a first or riser mounting portion 52, through which the tapped bores 44 and smooth bores 46 are formed, for mounting the mid-plate 30 to the riser 14. The riser mounting section further defines a lower arm attachment face 53. Extending from the riser mounting portion 52 is a clamp or accessory mounting portion 54. The accessory mounting portion extends from the riser mounting portion 52 in any number of selected orientations, as discussed more fully herein. The accessory mounting portion 54 further includes locking or positioning bores 56, which may interact with locking pins or screws 58 to hold an accessory or clamp motor, such as a clamp 62, relative to the accessory mounting portion 54 of the mid-plate 30.

In this way, the clamp 62 may be positioned relative the mid-plate 30 and secured in the selected position with the locking pins 58. Also, as discussed more fully herein, because the accessory mounting portion 54 may extend from the riser mounting portion 52 in any selected manner, the position of the clamp 62 can be selected from a plurality of positions relative to the riser 14. The locking pins 58 pass through or interact with the bores 64 of the clamp 62 to hold the clamp 62 relative the accessory mounting portion 54.

Extending from or associating with the clamp 62 is a first or upper clamp arm 70. The upper clamp arm 70 interacts with the clamp 62 through an axle or spindle 72. The axle 72 cooperates with a bore 74 formed in the clamp arm 70, such that the clamp arm 70 may be moved through a plurality of positions. Formed in the clamp arm 70 is a set of locking and positioning bores 76. The locking and positioning bores 76 allow fasteners or positioners 78 to position a first or upper foot or finger 80 relative to the first arm 70. The first finger 80 may include a mounting portion 82 and a structure or member orienting portion 84. Therefore, the clamp arm 70 may move the finger 80 relative the clamp 62 through a selected range.

A lower arm or L-arm 90 includes a first or mounting section 92 and a second or positioning section 94. The mounting section 92 includes a plurality of through bores, generally including at least two peg bores 96 and 98 and two screw bores 100 and 102. Positioning pegs 104 and 106 are adapted to be placed through the smooth bores 96 and 98, while screws 108 and 110 are adapted to be positioned through the tapped bores 100 and 102.

The lower arm attachment face 53 of the mid-plate 30 defines a plurality of bores. The plurality of bores includes smooth bores 112, 114, 116, and 118 and a plurality of tapped bores 120, 122, 124, and 126. The plurality of bores 112-126 allow the lower arm 90 to be positioned in one of a plurality of positions. The first peg bore 112 and second peg bore 114 form a first attachment position 128. The second peg bore 114 and the third peg bore 116 form a second position 130, while the third peg bore 116 and fourth peg bore 118 form a third position 132. The three positions or sets of peg bores 128-132 allow the lower arm 90 to be positioned in any one of three positions. The correlating screw bores 120-126 allow the lower arm 90 to be permanently or securely affixed relative to the peg bores section 128-132.

The mounting positions 128-132 allow the lower arm 90 to be selectively positioned relative the bores 112-126 with the pegs 104 and 106 and securely fixed in place with the screws 108 and 110. It will be understood, however, that any appropriate number of bores 112-126 may be formed on the lower arm mounting face 53. Similarly, any appropriate number of mounting positions may be formed on the lower arm mounting face 53. Moreover, the mounting positions 128-132 may be spaced apart at any appropriate distance. Nevertheless, the mounting positions 128-132, according to various embodiments, may be positioned about two to about twenty millimeters apart. In this way, the lower arm 90 can be moved in increments of the mounting positions 128-132 to provide a desired space between the upper arm 70 and the lower arm 90.

A spacer 150 and a shim 152 may be positioned between the lower arm 90 and the lower arm mounting face 53 to select a horizontal spacing between the lower arm 90 and the mid-plate 30. It will be understood that a plurality of spacers 150 and shims 152 may be provided and selected to achieve a selected horizontal distance between the lower arm 90 and the mid-plate 30.

On the positioning section 94 is formed a plurality of bores, including smooth bores 160 and tapped bores 162. A second positioning finger 170 includes a mounting section 172 and a holding section 174. Formed through the mounting section 172 is a plurality of bores that receive attachment members 176, which mate with the appropriate bores 160 and 162 formed in the positioning portion 94 of the lower arm 90. Therefore, the second finger 170 can be positioned longitudinally along the length of the positioning section 94 of the lower arm 90.

Also, a vertical distance of the positioning finger 70 and the lower arm 90 can be selected relative the surface 12 because of the plurality of bores 112-126 formed in the mid-plate 30. Therefore, a vertical position, as discussed further herein, can be selected because of the plurality of bores 112-126 formed on the mid-plate 30. Similarly, a longitudinal position, as discussed further herein, can be selected because of the plurality of bores 160 and 162 formed on the positioning section 94 of the lower arm 90.

As illustrated, the fixture 10 is a modular system that allows for interconnections of a plurality of portions, such as the mid-plate 30 and the lower arm 90, to provide for a plurality of orientations of the various portions of the fixture 10. For example, the mid-plate 30 includes the plurality of positioning bores 112-126 to allow for a selection of the vertical position of the lower arm 90. Similarly, the lower arm 90 includes the positioning section 94, which includes the plurality of positioning bores 160-162, to provide for a selected longitudinal position of the second finger 170. In addition, the mid-plate 30 may be selectively designed and formed, such that the clamp 62 is oriented and positioned at various positions relative the lower arm 90 and the riser 14. Various embodiments, for example, those discussed herein, provide for a plurality of modular portions, which may be selected to provide for a selected orientation of the modular portions relative to the other modular portions, such that a member or structure is held at a selected position.

With continuing reference to FIG. 1 and additional reference to FIG. 2, the fixture 10 can be assembled according to various dimensions relative to the fixture 10 itself and/or the surface 12, to which the fixture 10 is mounted. The various different dimensions provide for an absolute indication of the fixtures 10 position, relative to the surface 12, and various orientations of the fixture 10 relative to a structure or member, that is to be positioned or held with the fixture 10.

A first coordinate or positioning indication A selects an angle of the clamp 62 relative to a plane parallel to the surface 12. Specifically, the angle A is the angle between the plane 180, which is parallel to the surface 12, and an axis 182, which passes through the bore 74 of the clamp 62. The angle A defines the angular position of the clamp 62 relative to the riser 14 and the surface 12. As described further herein, the angle A may be altered by selecting one of a plurality of various mid-plates 30 or one of a plurality of clamps 62.

A second coordinate or position indication B is the distance between a first line 186 normal with the surface 12, which passes through a center point of a selected plurality of the bores 44 and 46 formed in the mid-plate 30. The distance B is measured between the first line 186 and a second line 188, also normal to the surface 12 and passes through the center of the bore 74 in the clamp 62. The indication B describes or selects a horizontal position of the clamp 62 relative the riser 14 and the surface 12. It will be understood that the horizontal position B can be selected depending upon the selected mid-plate 30 or the selected clamp 62. Therefore, the position distance B can be altered depending upon the selected mid-plate 30 and clamp 62.

A third coordinate or position indication C selects a length of the first arm 70. The indication C is measured between a first line 190, which substantially defines a center or axis along which a first bore 76 extends. A second line 192 substantially perpendicular to line 172 and passing through the center of the bore 72 further defines the indication C. Therefore, the indication C is substantially defined as the distance between the first line 190 and the second line 192 and substantially defines the length of the first arm 70. Therefore, the indication C can be changed by selecting one of a plurality of the first arm 70.

A fourth coordinate or position indication L substantially defines the length or space provided by the lower arm 90. Generally, at the indication L is the distance between a first line 200 and a second line 202. The first line 200 passes substantially through a first bore 160 formed in the lower arm 90. The second line 202 is substantially parallel and adjacent to the mounting face 53 of the mid-plate 30. Therefore, the indication L substantially defines the distance that the lower arm 90 extends from the mid-plate 30 and the range at which the second finger 170 can be positioned. The indication L may also be altered by positioning or selecting various spacers 150 and shims 152. Therefore, the selected shim 152 or spacer 150 can lengthen the indication L by repositioning the lower arm 90 further from the mid-plate 30. This allows the indication L to be further selected without replacing the lower arm 90.

A fifth coordinate or position indication Y substantially defines a distance between the surface 12 and a line 210, which is substantially parallel with the surface 12, and extends along a bottom portion 70b of the first arm 70. Therefore, the indication Y substantially defines a maximum distance between the first arm 70 and the surface 12. The indication Y may be altered by selecting various risers 14, mid-plates 30, clamps 62, or first arms 70. Because of this selectability, the indication Y may be substantially variable and specifically selected for a particular member or structure to be held.

A sixth coordinate or position indication G may also be selected. The indication G extends substantially between the line 210, which is substantially parallel to the surface 12, and a second line 216 that extends from a top surface 90a of the lower arm 90, which is also substantially parallel to the surface 12. Therefore, the indication G generally defines the distance between the first arm 70 and the second arm 90. Moreover, indication G also determines the distance between the first finger 80 and the second finger 170, which may be positioned and fixed relative to the first arm 70 and the second arm 90. The indication G may be altered by selecting various mid-plates 30 and first arms 70.

Alternatively, the indication G may be altered by repositioning the lower arm 90 between the positions 128-132 formed on the mounting face 53. For example, the lower arm 90 may be positioned at the first indication G when the lower arm 90 is fixed relative the mid-plate 30 at the first position 128. Nevertheless, the indication G changes to indication G when the lower arm 90 is moved to the second position 130 by repositioning and refixing the lower arm 90 relative to the mid-plate 30. It will be understood that any one of a plurality of indications G may be selected by repositioning the lower arm 90 relative to the mid-plate 30.

A seventh coordinate or position indication X is defined between the surface 12 and the line 216. Therefore, the indication X substantially defines the distance from the top 90a of the lower arm 90 to the surface 12. The indication X can be used to determine the clearance needed for the structure or member, which is to be held in the fixture 10. Repositioning the lower arm 90 relative to the mid-plate 30 can alter the indication X. Alternatively or in addition, selecting one of a plurality of the risers 14 may also alter the indication X. Therefore, any appropriate indication X can be selected by selecting the appropriate riser 14 and the appropriate position of the lower arm 90 relative to the mid-plate 30.

An eighth coordinate or position indication Z is substantially defined as a distance between the surface 12 and the line 180, which is substantially parallel to the surface 12 and passes through the center of the bore 74 of the clamp 62. Therefore, the indication Z substantially defines the height or distance of the clamp from the surface 12. The indication Z can be altered by, for example selecting the riser 14 to include a selected height. In addition or alternatively, the mid-plate 30 may be selected to provide a portion of the indication Z. Also, the clamp 62 itself can be chosen to determine a portion of the selected indication Z.

Therefore, the fixture 10 can be positioned and augmented by any one of a number of choices, further described herein, to alter the eight different indications, including: A, B, C, L, Y, G, X, and Z. Each of these eight indications define the fixture 10 relative to the surface 12. The indications also define the fixture 10 relative to the member to be held. Therefore, a structure or member may be positioned relative the fixture 10 and held in place in an appropriate or selected position by selecting the required indications among the eight above described indications to provide for an appropriate orientation of the fixture 10 relative the member and surface 12.

With reference FIG. 1 and additional reference to FIGS. 3a and 3b, the mid-plate 30, according to various embodiments, will be discussed in greater detail. The mid-plate 30 generally includes the mounting section 52 and the clamp mounting portion 54. The lower arm mounting face 53, defined by the riser mounting section 52, has formed therein the plurality of bores 112-126. As discussed above, the first peg bore 112 and second peg bore 114 form the first lower-arm mounting position 128. Similarly, the second peg bore 114 and the third peg bore 116 form the second mounting position 130, while the third peg bore 116 and the fourth peg bore 118 form the third mounting position 132.

Each of the mounting positions 128, 130 and 132 are generally positioned at a selected distance apart. Therefore, as the lower arm 90 is moved from one mounting position to another, in sequence, a selected distance is traveled by the top 90a of the lower arm 90. For example, the distance between each of the consecutive mounting sections, such as the first mounting position 128 and the second mounting position 130 is about 10 mm. It will be understood, however, that any appropriate distance between the various mounting positions may be selected and formed. Moreover, it will be understood that more than the three mounting positions 128-132 may be formed on the mid-plate 30.

In the mid-plate 30, the clamp mounting section 54 extends above the riser mounting section 52. A rearward face 300 of the clamp mounting section 54 is angled toward a forward face 302. The rearward face 300 has an angle or changing point 304 and a top point 306. The top point 306 is laterally offset from the angle point 304. For example, the top point 306 may be about 10 mm to about 30 mm offset from the angled point 304. Nevertheless, it will be understood that the top point 306 may be aligned with the angle point 304 or offset a distance greater than approximately 30 mm.

The clamp mounting portion 54 also includes a forward transition point 308, which is horizontally and laterally offset from the top point 306. The forward transition point 308 may be horizontally offset any appropriate distance, but-generally about −20 to about 150 mm. Moreover, the forward transition point 308 may generally be vertically offset from the top point 306 about 10 mm to about 50 mm. Therefore, the clamp mounting section 54 has a profile, which is angled forward toward the forward face 302. When the clamp 62 is mounted to the clamp mounting section 54, the clamp 62 is also angled substantially toward the forward face 302.

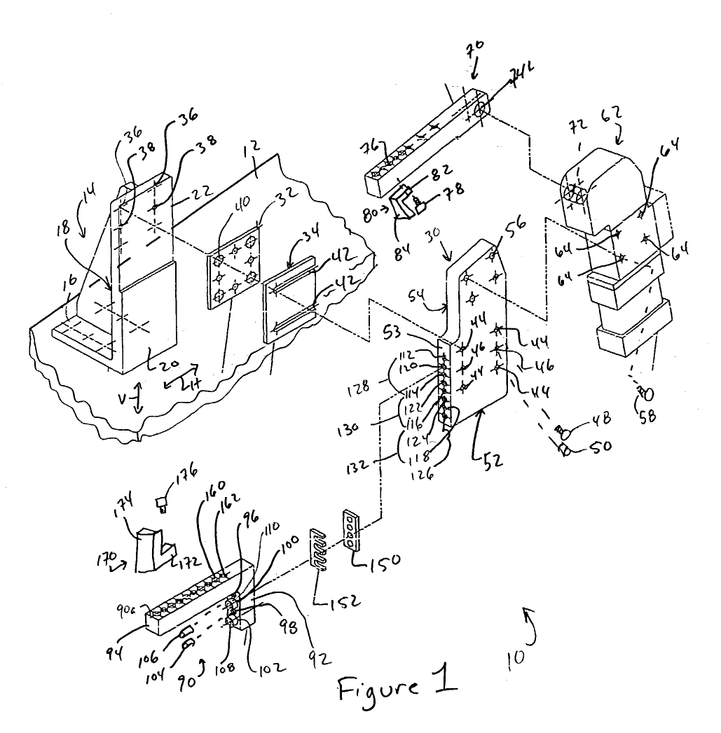

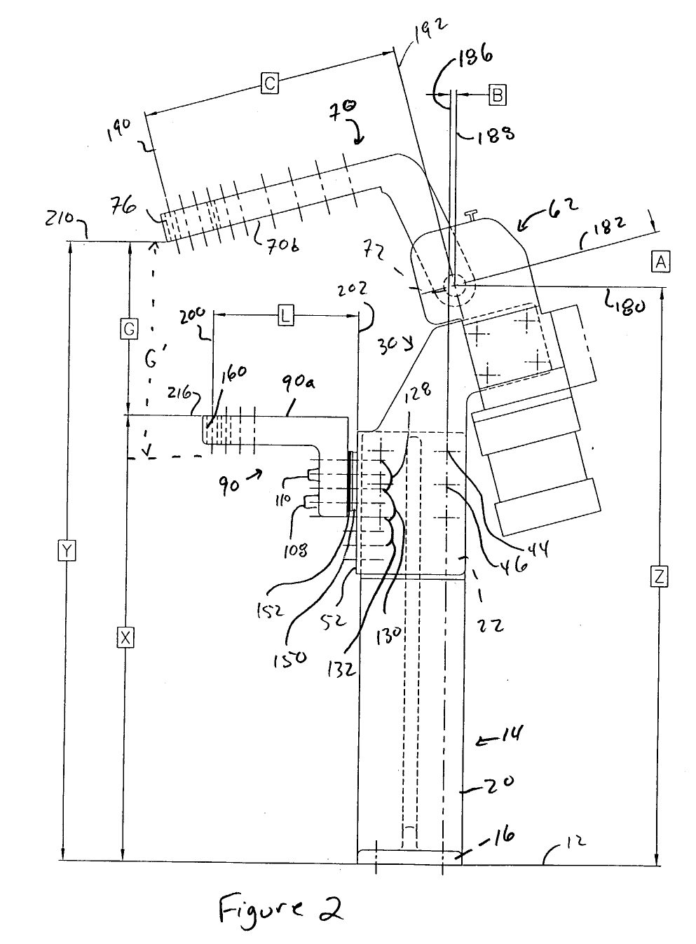

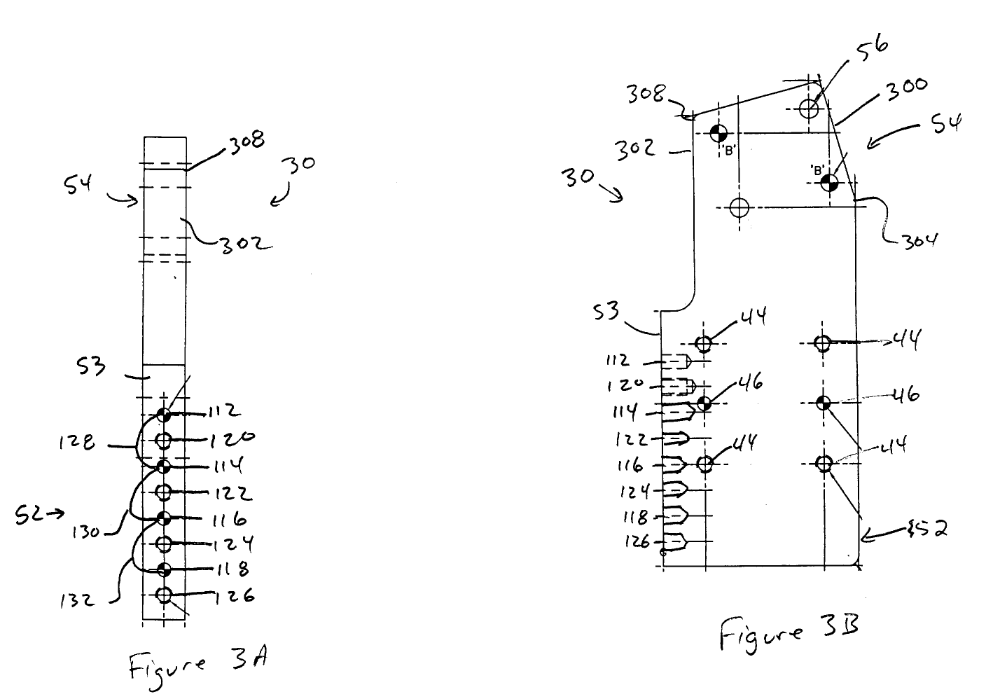

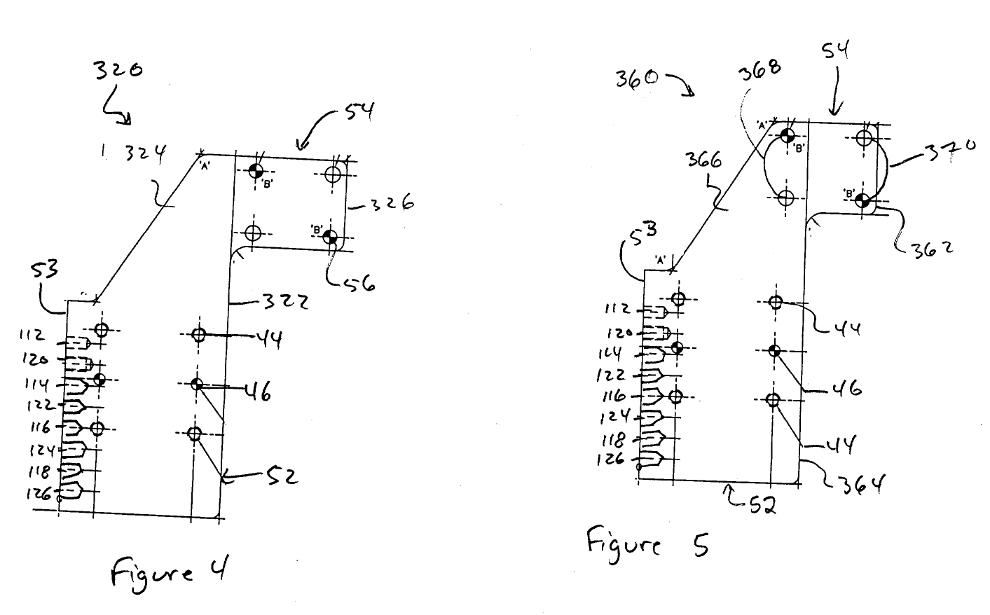

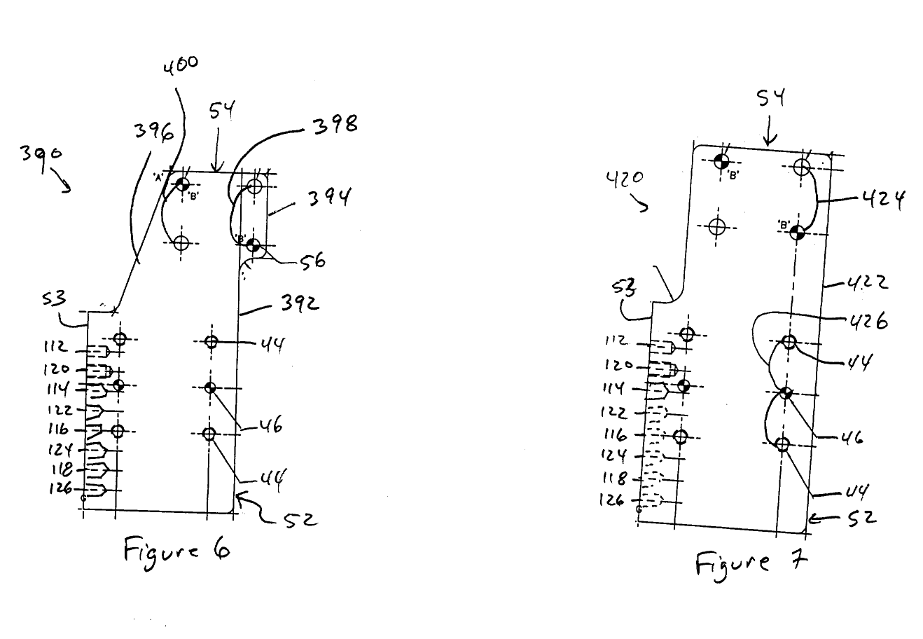

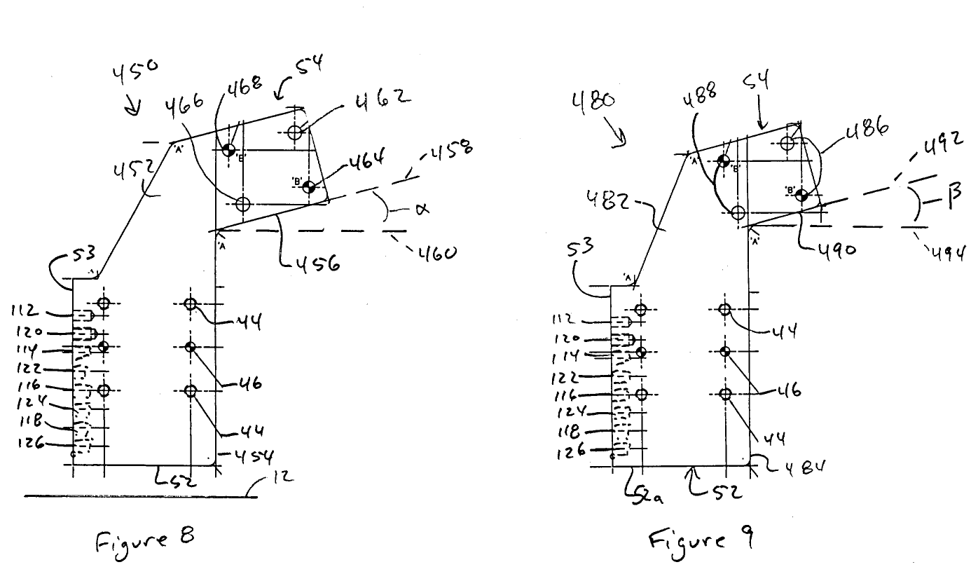

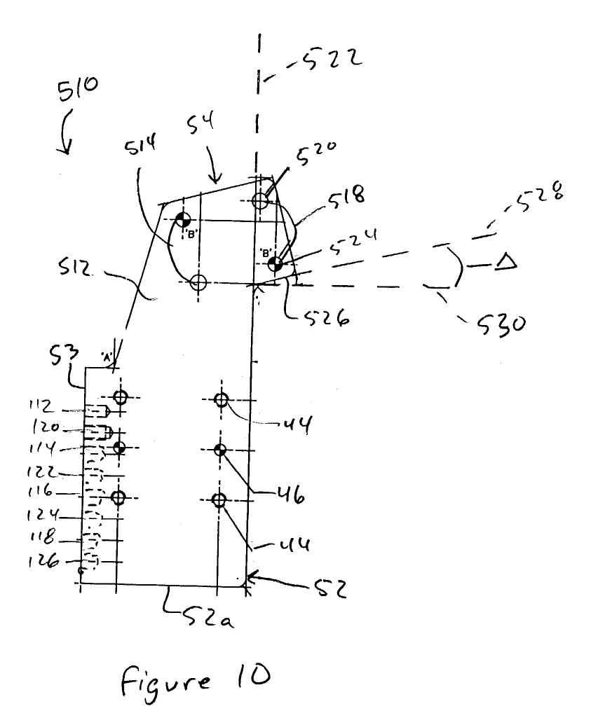

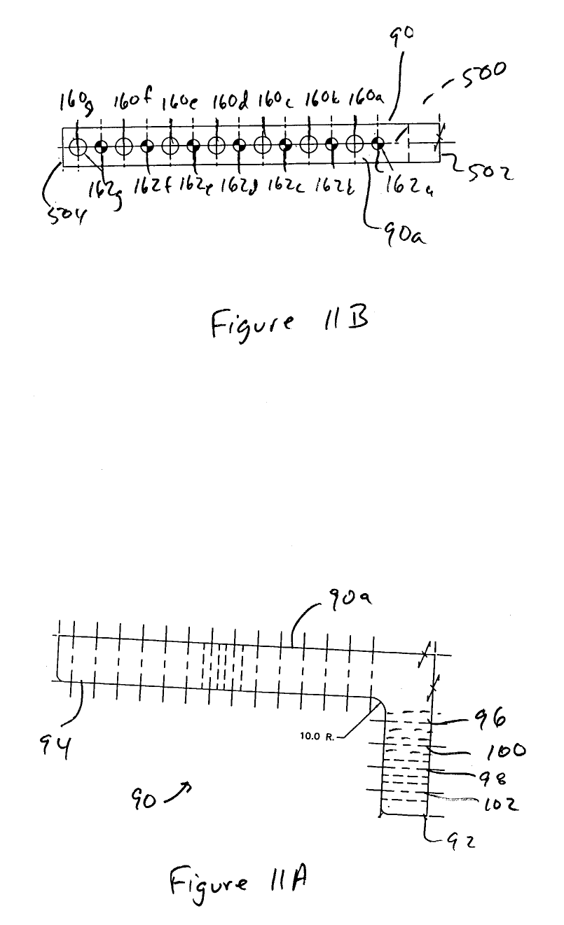

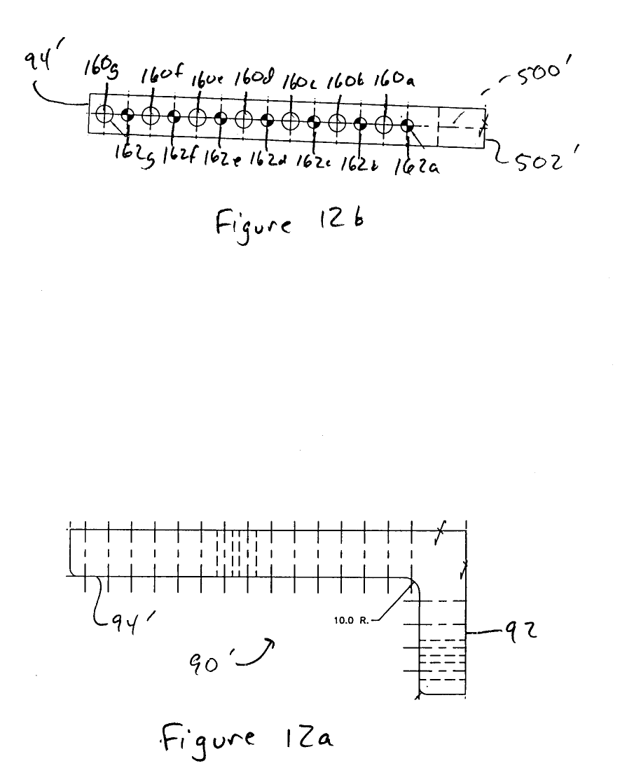

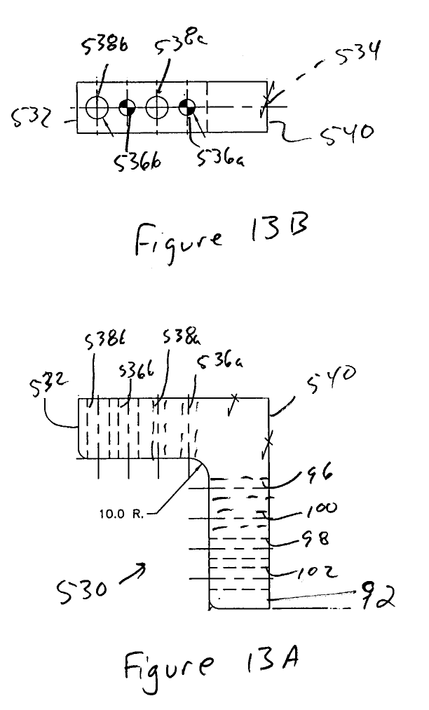

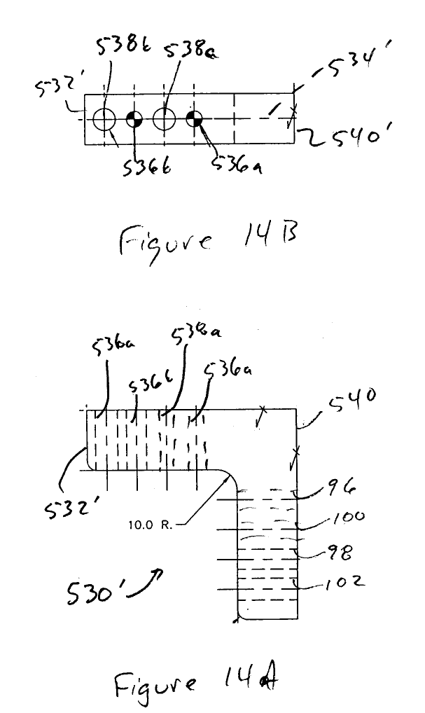

With reference to FIG. 4, a mid-plate 320, according to an alternative embodiment is illustrated. Here like reference numerals indicate like portions of the mid-plate 320 and the mid-plate 30 illustrated above. The mid-plate 320 includes the riser mounting portion 52 and the clamp mounting portion 54. The riser mounting portion 52 includes the lower arm mounting face 53 into which the plurality of bores 112-126 are formed. It will be understood that the plurality of bores 112-126 form each of the plurality of mounting positions 128-132. The mounting positions 128-132 may be substantially similar or differ from the mounting positions as included in the first mid-plate 30. Specifically, the distance between the various mounting positions 128-132 may differ as may the number of the mounting positions. The riser mounting section 52 also includes the tapped bores 44 and the smooth bores 46 for mounting the mid-plate 320 to the riser 14.

The clamp mounting section 54 is substantially offset from the riser mounting section 52. The riser mounting section 52 includes a back wall or face 322 and the clamp mounting section 54 substantially extends rearwardly of the back wall 322. Nevertheless, a neck or connecting region 324 extends between the clamp mounting section 54 with the riser mounting section 52. Moreover, the clamp mounting section 54 includes the bores 56, which allow the clamp 62 to be attached or fixed relative the clamp mounting section 54.

A rear wall 326 of the clamp mounting section 54 may be any appropriate distance from the rear wall 322 of the riser mounting section 52. The rear wall 326 of the clamp mounting section 54 is about 30 mm to about 120 mm away from the rear wall 322 of the riser mounting section 52. Therefore, the bores 56 may be positioned in the clamp mounting section 54 at any appropriate position to allow for fixation of the clamp 62 to the clamp mounting section 54.

Because the clamp mounting section 54 is offset from the riser mounting section 52, the clamp 62 or the first arm 70 can be moved to a selected position that is similarly offset from the lower arm 90. If the clamp mounting section 54 were not so far offset from the rear wall 322 of the riser mounting section 52 the clamp would be closer to the lower arm mounting face 53. Moreover, each of the bores 56, to mount the clamp 62, are also rearward of the rear wall 322 of the riser mounting section 52. Therefore, a substantial portion of the clamp 62 is positioned rearward of the rearward wall 322 of the riser mounting portion 52.

With reference to FIG. 5, a mid-plate 360, according to a second alternative embodiment, where like portions are marked with like reference numerals as the first embodiment mid-plate 30, is illustrated. Generally, the mid-plate 360 includes the riser mounting portion 52 and the clamp mounting portion 54. The riser mounting portion 52 includes the lower arm mounting face 53 that defines the mounting positions 128-132. Moreover, it will be understood that the distance between the consecutive mounting positions 128-132 may be the same or different than that previously discussed. In addition, there may be more than three mounting positions formed in the lower arm mounting face 53. Also, the riser mounting section 52 includes the bores 44 and 46 to mount the mid-plate 360 to the riser 14.

Disposed above the riser mounting section 52 is the clamp mounting section 54. A rear wall 362 of the clamp mounting section 54 is positioned rearwardly of a rearward wall 364 of the riser mounting section 52. Therefore, the clamp mounting portion 54 is positioned, at least partially, rearwardly of the riser mounting section 52. Nevertheless, a neck or connection portion 366 extends between the riser mounting section 52 and the clamp mounting section 54.

The clamp mounting section 54 includes a first set of bores 368 and a second set of bores 370. The first set of bores 368 are positioned forward of the rearward wall 364 of the riser mounting section 52. That is the first set of bores 368 are positioned between a line defined by the lower arm mounting face 53 and the rearward wall 364 of the riser mounting section 52. The second set of bores 370, however, is positioned rearwardly over the rear wall 364 of the riser mounting section 52.

The first set of bores 368 and second set of bores 370 allow the clamp 62 to be mounted to the clamp mounting section 54 in a selected position. Although, all of the bores are not positioned rearwardly over the rear wall 364 of the riser mounting section 52, as illustrated in the first alternative mid-plate 320. Therefore, the clamp 62 is not positioned, at least when mounted to the clamp mounting section 54, as rearwardly as it may be when the first alternative mid-plate 320 is used. The rearward wall 362 of the clamp mounting section 54 may be disposed rearwardly of the rear wall 364 of the riser mounting section 52 any appropriate distance. However, it is generally about 20 mm to about 80 mm rearward of the rearward wall 364 of the mounting plate 52. Nevertheless, it will be understood that the rearward wall 362 of the clamp mounting section 54 may be in any appropriate position. Also, the first set of bores 368 are positioned forward of the rearward wall 364 of the riser mounting section 52, such that the clamp 62, when mounted to the mid-plate 360 is positioned near the riser mounting section 52.

With reference to FIG. 6, a third alternative mid-plate 390 is illustrated. Like portions of the mid-plate 390 are given-like reference numerals as the first mid-plate 30. The mid-plate 390 includes the riser mounting section 52 and the clamp mounting section 54. The riser mounting section 52 generally includes the lower arm mounting face 53, which defines the mounting positions 128-132, which allow the lower arm 90 to be mounted and positioned relative the mid-plate 390. Nevertheless, as discussed above, the mid-plate 390 may include any appropriate number of positions to mount the lower arm 90 to the mid-plate 390. The mid-plate 390 also includes the mounting bores 44 and 46 to mount the mid-plate 390 to the riser 14. The riser mounting portion 52 also includes a rear wall 392.

The clamp mounting portion 54 includes a rear wall 394, which is positioned rearwardly of the rearward wall 392 of the riser mounting section 52. Generally, the rearward wall 394 of the clamp mounting section 54 is positioned about 5 mm to about 50 mm rearward of the rearward wall 392 of the riser mounting section 52. Nevertheless, a neck or connecting portion 396 interconnects the clamp mounting portion 54 with the riser mounting section 52.

A first set of bores 398 are formed in the clamp mounting section 54 in the space between the rearward wall 392 of the riser mounting section 52 and the rearward wall 394 of the clamp mounting section 54. A second set of bores 400 are formed in the clamp mounting section 54 forward of the rearward wall 392 of the riser mounting section 52.

Because the first set of bores 398 are near the rearward wall 392 of the riser mounting section 52, the clamp 62, when mounted to the first set of bores 398 is also near the riser mounting section 52. Therefore, the clamp 62 can be positioned closer to the riser mounting section 52 when compared to the previously discussed embodiments, save for the mid-plate 30.

With reference to FIG. 7, a fourth alternative embodiment of a mid-plate 420 is illustrated. Like portions of the mid-plate 420 are given like reference numerals to the previous embodiments. The mid-plate 420 generally includes the riser mounting section 52 and the clamp mounting section 54. The riser mounting section 52 defines the lower arm mounting face 53, which defines the mounting positions 128-132. As discussed above, varying amounts of the mounting positions 128-132 may be provided to select the position of the lower arm 90. Moreover, the bores 44 and 46 allow the mid-plate 420 to be fixed to the riser 14. Extending from the riser mounting section 52 is the clamp mounting section 54. A rearward wall 422 of the mid-plate 420 defines a rearward wall of both the riser mounting section 52 and the clamp mounting section 54. Because the rear wall 422 defines the rear wall of both the riser attachment sections 52 and the clamp attachment section 54, the clamp attachment section 54 is substantially aligned with the riser attachment section 52.

A first set of bores 424 include a center point which is substantially aligned with a first set of bores 426 in the riser attachment section 52. Therefore, when the clamp 62 is affixed to the clamp attachment section 54, the clamp 62 is substantially aligned with the riser attachment section 52. Moreover, the rotational axle 72 of the clamp 62 is also substantially aligned with the riser attachment portion 52. This moves the clamp 62 towards the clamping area which is between the final position of the upper arm 70 and the lower arm 90.

With reference to FIG. 8, a fifth alternative embodiment of a mid-plate 450 is illustrated. The mid-plate 450, where like portions are referenced with like numerals as the above embodiments, generally includes the riser attachment section 52 and the clamp attachment section 54. Extending between and interconnecting the riser attachment portion 52 and the clamp attachment portion 54 is a neck or connector 452.

Formed on the riser attachment portion 52 is the lower arm attachment faced 53. The lower arm attachment face 53 again defines attachment positions 128-132. As discussed above, it will be understood that a differing number of bores and attachment positions may be provided on the lower arm attachment face 53. In addition, the riser attachment section 52 further defines the attachment bores 44 and 46. Therefore, the mid-plate 450 may be affixed to the riser 14.

The riser attachment section 52 defines a rear wall 454. The clamp attachment section 54 extends rearwardly of the rear wall 454 of the riser attachment section 52. In addition, the clamp attachment section 54 is angled upwards as it extends rearwardly of the rear wall 454 of the riser attachment section 52. Specifically, a bottom 456 of the clamp attachment section 54 extends along a line 458. The line 458 forms an angle α with a line 460 which is substantially parallel with the surface 12. It will be understood that the angle α can be selected to be any appropriate angle to achieve a selected orientation or position of the fixture 10.

The clamp attachment section 54 further includes a first bore 462, a second bore 464, a third bore 466, and a fourth bore 468. Each of the bores 462-468 is substantially not aligned with each of the other bores relative to the surface 12 or the line 460. Nevertheless, each of the bores 462-468 is formed generally equidistant from an outside edge of the clamp attachment section 54 such that the bores are substantially aligned within the clamp attachment section 54. Therefore, the clamp 62, which is positioned relative the clamp attachment section 54 via the bores 462-468, may include the angle α such that the clamp 62 is angled relative the surface 12 substantially equal to the angle α of the clamp attachment section 54.

Moreover, the clamp 62 is positioned substantially offset from the riser attachment section 52 because each of the bores 462-468 is positioned rearwardly of the rear wall 454 of the riser attachment section 52. It will be understood that each of the bores 462-468 may be positioned in the clamp attachment section 54 and the clamp attachment section 54 include dimensions of any selected amount such that the clamp 62 may be positioned relative the riser section 52 in a desired position.

With reference to FIG. 9, an alternative embodiment of a riser 480 is illustrated. The riser 480, where like numerals reference like portions as discussed above, generally includes the riser attachment section 52, the clamp attachment section 54, and, extending between the riser attachment section 52 and the clamp attachment section 54, a connector or neck 482. Defined by the riser attachment section 52 on the front portion is the lower arm attachment section 53. The lower arm attachment face 53 further defines the attachment positions 128-132. Therefore, the lower arm 90 may be positioned relative the mid-plate 480 using the attachment positions 128-132. Nevertheless, it will be understood that any appropriate number of connection positions may be provided on the lower arm attachment face 53. The riser-attachment section 52 further defines the bores 44 and 46 such that the mid-plate 480 may be fixed to the riser 14.

The riser attachment section 52 also defines a rear wall 484. At least a portion of the clamp attachment section 54 extends rearwardly of the rear wall 484 of the riser attachment section 52. Also, a first set of bores 486 are positioned rearwardly of the rear wall 484 of the riser attachment section 52. The first set of bores 486 are not necessarily positioned on the clamp attachment section 54 such that they are aligned with a line that is parallel to the rear wall 484 of the riser attachment section 52. Nevertheless, the first set of bores 486 are both positioned rearward of the rear wall 484. A second set of bores 488 is positioned forward of the rear wall 484 of the riser section 52. Therefore, the second set of bores 488 is substantially more aligned with the riser attachment section 52 than the first set of bores 486.

The clamp attachment section 54 includes a bottom or lower side 490 which defines a line 492 that is positioned at an angle β relative to a line 494 that is substantially parallel to a bottom 52a of the riser attachment section 52. Therefore, the clamp attachment section 54 extends both rearwardly of the rear wall 484 of the riser attachment section 52 and upwardly at the angle β. It will be understood that the angle β can be any appropriate angle selected to appropriately position the clamp 62 relative to the fixture 10.

The clamp attachment section 54, where the first set of bores 486 is rearward of the rear wall 484 and the second set of bores 488 is forward of the rear wall 484, of the riser attachment section 52, places the clamp 62, when attached to the clamp section 54, near the riser attachment section 52. Therefore, the clamp 62 may be angled relative the riser attachment section 52 yet positioned near the riser attachment section 52. It will be understood that the position of at least the first set of bores 486 may be selected with the size of the clamp attachment section 54 such that the clamp 62 is positioned at an appropriate distance from the riser attachment section 52.

With reference to FIG. 10, an alternative embodiment of a mid-plate 510 is illustrated. The mid-plate 510, where like reference numerals reference like portions as previously discussed, generally includes the riser attachment section 52 which includes the bottom wall or portion 52a. Extending from the riser attachment section 52 is the clamp attachment section 54. Extending between and interconnecting the riser attachment section 52 and the clamp attachment section 54 is a neck or connector 512. The riser attachment section 52 includes the lower arm attachment face 53 which defines the attachment positions 128-132. As discussed above, the number of bores and attachment positions may be altered depending upon the selected orientation of the fixture 10. The riser attachment section 52 further includes the bores 44 and 46, that allow attachment of the mid-plate 510 to the riser 14.

The clamp attachment section 54 includes a first set of bores 514 that are substantially forward of a rear wall 516 of the riser attachment section 52. A second set of bores 518 includes one bore 520 which intersects or overlaps a line 522 which is defined by the rear wall 516. A second bore 524 of the second set 518 is positioned rearward of the line 522. Therefore, only one bore defined by the clamp attachment section 54 is positioned substantially entirely rearward of the line 522. A bottom wall 526 of the clamp attachment section 54 defines a line 528 which is at an angle γ from a line 530 that is substantially parallel to the bottom 52a of the riser attachment section 52. Therefore, the clamp attachment section 54 is angled at the angle γ relative to the bottom 52a of the riser attachment section 52. The positioning of the sets of bores 514 and 518 position the clamp 62, when affixed to the bores 514 and 518, substantially near to the riser attachment section 52. Nevertheless, the angle γ allows the clamp 62 to be angled relative to the riser attachment section 52 when the clamp is attached to the clamp attachment section 54.

It will be understood that the first set of bores 514 can be positioned forward of the rear wall 516 of the riser attachment section 52 to position the clamp 62 in a selected orientation. Similarly, the second set of bores 518 can be positioned such that the clamp 62 is positioned closely to the riser attachment section 52. Nevertheless, the bores 516 and 518 may be positioned at any position that is appropriate to provide the selected position of the clamp 62. Moreover, the angle γ can be selected such that the clamp 62 includes an angle relative to the riser attachment section 52 for a selected application.

With reference to FIGS. 11A and 11B, the lower arm 90, according to an embodiment, includes the mid-plate attachment portion 92: and the finger attachment portion 94. As described above, the mid-plate attachment portion 92 includes two smooth bores 96 and 98 and two tapped bores 100 and 102. The bores in the mid-plate attachment section 92 allow the lower arm 90 to be fixed relative the mid-plate 30 in a selected position, but particularly in the attachment positions 128, 130, and 132. Once the lower arm 90 is attached to the appropriate attachment positions, the plurality of bores, including the smooth bores 162 and the tapped bores 160 formed in the finger attachment section 94 may be used to position the second finger 170. For example, as illustrated here in an embodiment of the lower arm 90, there may be seven smooth bores 162A-162G and seven tapped bores 160A-160G. Generally, the bores are positioned along a longitudinal axis 500 defined by the top surface 90a of the finger attachment portion 94. Generally, a center point of each of the plurality of bores 162A-162G and 160A-160G are positioned on the longitudinal axis 500.

Each of the plurality of bores may be positioned at any selected distance from an adjacent or first end 502 of the lower arm 94. That is, the bores 162 and 160 are positioned along the finger attachment portion 94 between the first end 502 and a second end 504 of the finger attachment portion 94. If the shim 152 and spacer 150 are used the holes may be positioned generally about 5 mm to about 30 mm apart where the first smooth bore 162A is between about 20 and about 60 mm from the first end 502. It will be understood that the bores 160 and 162 may be positioned any appropriate distance apart to allow for an appropriate positioning of the second finger 170. Generally, the finger positioning portion 94 is between about 10 mm and about 500 mm in length with the bores 160 and 162 positioned appropriately along the length of the finger attachment section 94. Nevertheless, the finger-attachment section 94 may be any appropriate length as needed to provide the selected variable.

With reference to FIGS. 12A and 12B, a lower attachment arm 90′, where like numerals reference like portions as the above described embodiments, includes the mid-plate attachment section 92 and the finger attachment section 94. Formed along a longitudinal axis 502′ of a finger attachment section 94′ is the plurality of bores 160 and 162. Generally, when no shim is used, the length of the finger attachment section 94′ may be augmented to include a different length. Similarly, the bores 160 and 162 may be positioned at different positions along the finger attachment section 94′. Generally, the first smooth bore 162A may be positioned between a 45 and 55 mm from a first end 502′ of the finger attachment section 94′. Again, each of the plurality of bores may be positioned between about 5 mm to about 30 mm apart beginning from this first position; Nevertheless, the bores 162 may include differing distances from the first end 502′ compared to the distance of the bores in the lower arm 90 and their distance from the first end 502 of the finger attachment section 94.

With reference to FIGS. 13A and 13B, an alternative embodiment of a lower arm 530 is illustrated. The lower attachment arm 530, where like reference numerals reference like portions of the above described embodiments, includes a mid-plate attachment section 92. The mid-plate attachment section 92 includes the bores 96-102 for attachment of the lower arm 530 to the mid-plate 30.

The lower arm-530 also includes a finger attachment section 532 which defines a longitudinal axis 534. The finger-attachment section 532 includes a first smooth bore 536A and a second smooth bore 536B. The finger attachment section 532 also includes a tapped bore 538A and a second tapped bore 538B. Similar to the plurality of bores 160 and 162 formed in the first embodiments of the lower arm 90, the bores 536 and 538 of the alternative lower arm 530 are provided to allow attachment of the second finger 170 relative the lower arm 530. Nevertheless, it will be understood, that the lesser plurality of the bores 536 and 538 provides for a limited number of positions which the lower arm 530 provides for attachment of the second finger 170.

The first bore 536A may be positioned a selected distance from a first end 540 of the finger attachment section 532. Generally, the first bore 536A is positioned about 25 mm to about 55 mm from the first end 540 of the finger attachment section 532. The bores may be positioned about 10 mm to about 20 mm apart extending along the longitudinal axis 534. It will be understood, however, that the first bore 536A may be positioned at any appropriate distance from the first end 540 while each of the bores may be positioned at any appropriate distance from each other. Generally, the first bores are positioned about 35 mm to about 45 mm from the first end 540 when the shim 152 and the spacer 150 are positioned between the lower arm 530 and the arm attachment face 53 of the mid-plate 30.

With reference to FIGS. 14A and 14B, an alternative lower arm 530′ is illustrated. The alternative lower arm 530′ is similar to the alternative lower arm 530 except that a length of a finger attachment portion 532′ includes a different distance than the length of the finger attachment portion 532. Generally, the lower arm 530′ may be used when no shim 152 and no spacer 150 are provided between the lower arm 530′ and the arm attachment face 53 of the mid-plate 30. Therefore, the first bore 536A may be positioned along a longitudinal axis 534′ a distance from a first end 540′ of the finger attachment portion 532′ at a different position than the first bore 536A of the lower arm 530. Generally, the first bore 536A is positioned about 45 mm to about 55 mm from the first end 540′ of the lower arm 530′. Each of the other bores 536B and 538 A and B may be positioned at any appropriate distance apart from one another along the axis 534′. Nevertheless, the bores are generally positioned about 5 mm to about 30 mm apart.

It will be understood that the lower arms discussed above 94, 94′, 530, and 530′ are merely exemplary in nature and that any appropriate lower arm may be used with the fixture 10. Specifically, any number of lower arms may be provided which include finger attachment portions of any appropriate length including any appropriate number of bores positioned an appropriate distance apart. The ability to provide a plurality of the lower arms including varying lengths and positions of the finger attachment bores allows for a plurality of fixture designs. A single mid-plate may be varied by providing a different lower arm such that a single mid-plate may be used in a great number of designs for the fixture 10. Specifically, altering the lower arm or providing a different lower arm can allow the fixture 10 to accommodate different sets of variables, including the variables A, B, C, G, L, X; Y, and Z without providing an entirely new fixture. Therefore, it will be understood that the exemplary lower arms illustrated and described will not limit the number or size of lower arms that may be provided for use with the fixture 10.

Above discussed are a plurality of modular portions of the modular fixture 10 which can be interconnected to provide any one of a plurality of variations of the modular fixture 10. Described below is an exemplary method of using the modular fixture 10. It will be understood that the following discussion is merely exemplary of an embodiment of use and it is not meant to be a limiting description of the invention.

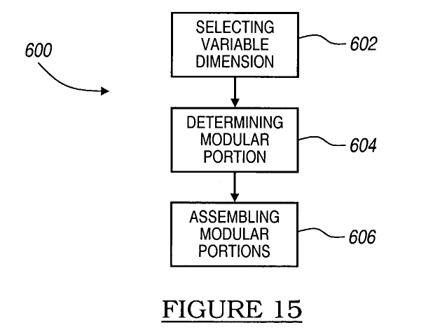

With reference to FIG. 2 and FIG. 15, a method of using 600 the modular fixture 10 generally includes the steps of first selecting or determining a variable dimension or indication in block 602. The modular portions, such as the mid-plate 30 and the lower arm 90′, are determined in block 604 to achieve the variable indications selected in block 602. Then, assembling the determined or selected modular portions from block 604 in block 606.

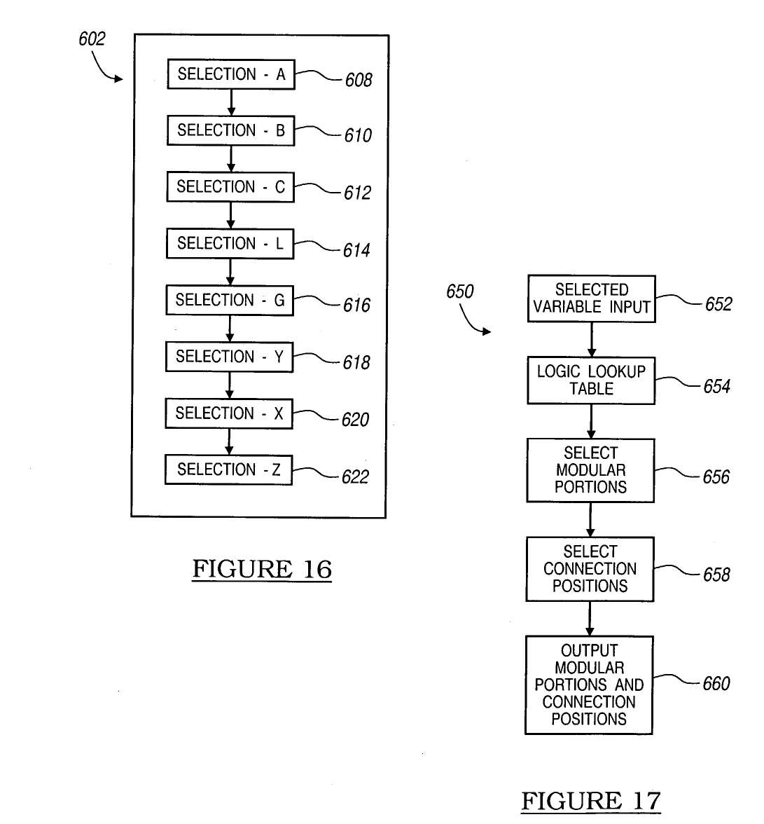

With continuing reference to FIG. 15 and further reference to FIG. 16, the block 602 of selecting variable dimension may include selecting any one of the plurality of dimensions, as illustrated in FIG. 2. Therefore, the block 602 for selecting variable dimensions may include at least selecting the dimension or angle A in sub-block 608, selecting the dimension B in sub-block 610, selecting the dimension of length C in sub-block 612, selecting the length L of the lower arm 90 in sub-block 614. Also, the gap dimension G may be selected in sub-block 616 to allow for an appropriate maximum or desired gap. Also, the distance Y from the surface 12 to the upper arm 70 is selected in sub-block 618. The height or indication Y may be selected in sub-block 620. Finally, the distance Z in sub-block 622 between the surface 12 and the center of the bore 72 and the clamp 62 is selected.

Therefore, selecting the variable dimension 602 may include selecting each of the variables in each of the sub-blocks 608-622 or any number thereof. For example, a user may desire to position a member and hold the member in a selected position relative to the surface 12. Therefore, the user is able to determine each of the variables such that the fixture 10 is able to hold the member relative to the surface 12 while work is being performed on the member.

It will also be understood that any one or selected plurality of the various sub-blocks 608-622 may be determined for various work steps where the various other variables are not particularly crucial. For example, it may be always be selected to have a work piece or member a particular distance from the surface 12 by selecting a distance for variable X in sub-block 620. It may be desired the distance X determined or selected in sub-block 620 remain constant for a plurality of different members upon which work is performed. Therefore, the value selected for variable X in sub-block 620 may remain constant while the dimensions for various other variables such as the gap for variable G in sub-block 616 may vary. Therefore, any one or all of the variables may be selected in block 602 without reselecting or re-determining each of the variables in block 602.

Generally, selecting the variable dimensions in block 602 will be dependent upon the member or surface on which work will be performed. Therefore, selecting a member or structure upon which work is performed may be an initial step carried out before block 602 of selecting variable dimensions. Also, as discussed above, selecting the various variables in block 602 may be dependent upon the structure or member upon which the work is performed and may alter or change as the structure or member upon work is to be performed changes.

With continuing reference to FIG. 15, the block 604 of determining the modular portions generally includes selecting the plurality of portions including an appropriate one of a plurality of the risers, appropriate mid-plate, an appropriate clamp, the appropriate upper arm, and the appropriate lower arm. The appropriate modular portions may be exactly as those discussed above or similar thereto. Regardless the portions chosen are only to create the dimensions selected in block 602.

The block 604 also includes determining how of the various portions or plurality of modular portions may be interconnected to provide the dimensions selected in block 602. For example, with additional reference to FIG. 2, the exemplary dimensions, selected in block 602, may be accomplished by providing the riser 14, the mid-plate 30, the clamp 62, the upper arm 70 and the lower arm 90. Therefore, these plurality of modular portions may be affixed relative one another to provide for the selected variables chosen in block 602. Moreover, it will be understood that the first finger-80 may be-affixed to the upper arm 70 using any of the plurality of bores 76 formed therein while the second finger 170 may be affixed to the lower arm 90 using any of the plurality of bores 160 formed therein. Because of this, determining the modular portions in block 604 may also include determining the appropriate location of the fingers 80 and 170. In addition, as discussed above, the lower arm may be positioned relative to the mid-plate 30 using any of the mounting positions 128-132. Therefore, determining the modular portions in step 604 further includes determining the appropriate position to mount the lower arm. Also, as discussed above, spacers and shims may be used in conjunction with the lower arm 90. Therefore, also determining the modular portions in block 604 may include determining whether shims or spacers are necessary to provide the variables selected in block 602.

Finally, the modular portions determined the block 604 are assembled in block 606. The modular portions are assembled in block 606 such that the various dimensions will be obtained once the modular fixture 10 is mounted to the surface 12. Therefore, the method 600 allows for the plurality of variables to be selected in block 602 and the modular portions easily determined in block 604 to provide for the various dimensions selected in block 602.

It will be understood that a individual or a computer will be able to determine either the selected variables in block 602 or the modular portions in block 604 to provide the selected variables from block 602.

With reference to FIG. 15, and further reference to FIG. 16, a computer program to perform the determination modular portions in the block 604 may-generally include the programming algorithms or portions 650. Generally, the program-650 may include a selected variable input block 652. At the selected variable input block 652, the selected variables are input into a computer system that may include a processor which can process the computer program. Therefore, the selected variables may be input and stored in memory or may be input directly into an accessible memory module to be processed by a processor.

The computer program 650 may also include a logic lookup table in block 654 that includes a list of each available modular portion. The look-up table in block 654 may also include a list of all possible connecting positions for the various modular portions. For example, the lookup table may include each or all of the possible plurality of the risers, the mid-plates, the clamps, the upper arms, and the lower arms. Therefore, the logic lookup table in block 654 includes each of the modular portions which may be assembled to provide for the selected variable input.

The program 654 processes the selected variables input into the block 652 with the logic lookup table in block 654 to determine which of the modular portions are required to provide the modular fixture 10 to obtain the selected variable inputs in block 652. After processing the logic lookup table in block 654 with the selected variable inputs in block 652, the computer program then selects the modular portions in blocks 656 required to obtain the selected variable inputs in block 652.

Generally, the computer program 650 is able to determine which of the plurality of modular portions may be assembled to provide for the selected variable inputs in block 652. The computer program 650 may also then determine the connection positions in blocks 658 required to also create the selected variable inputs in block 652. Determining the connection positions in block 658 may include reference to the look-up table in block 654. For example, the lower arm 90 may be required to be positioned in the first positioning position 128 to provide for the appropriate dimension for the variable X input in sub-block 620 and the variable G input in sub-block 616. Therefore, the computer program 650 is able to select the modular portion in block 656 and select the connection positions in block 658 to provide the selected variable inputs in block 652.

Finally, the computer program 650 is able to output the selected modular portions and the selected connection positions. Generally, the output in block 660 is in a human determinable or readable form such that an individual is able to obtain the selected modular portions and connect them according to the selected connection positions. In this way, the computer program 650 is able to determine the modular portions and the connection positions required to provide for the selected variable input in blocks 652. It will be understood, however, that the computer program may output a computer readable code such that a robot or other device may obtain and assemble the modular fixture 10.

Generally, the computer program 650 is able to obtain the output in block 660 in a timely manner due to the comprehensive and inclusive logic lookup table in block 654. Specifically, the logic lookup table in block 654 includes all of the modular portions and the available connecting positions that can be used to form the modular fixture 10. Because the logic lookup table 654 is comprehensive of all the modular portions and connecting sections, the program 650 will always be able to determine whether the modular portions are available to provide the selected variables input in block 652.

The modular system 10 allows a small number of modular portions that can be configured in a large plurality of positions. For example, 12 lower arms, 6 including shims and spacers and 6 not including shims and spacers, in conjunction with 8 various mid-plates may be interconnected, using the three connecting positions of the mid-plate, to provide for over 12,000 variations for the variables selected in block 602. That is, providing the modular system 10 provides for a large plurality of the final positions of the modular fixture 10 without providing an overwhelming number of modular portions that can be interconnected. Therefore, the logic lookup table 654 is reasonable in size and the program 650 is able to include the comprehensive list of the modular portions and connecting positions and the logic lookup table 654 without creating an arduous or time consuming processing time.

Therefore, the modular fixture 10 and the accompanying method 600 can allow an individual or a computer system to determine which of a plurality of modular portions is required to be and needs to be interconnected in the modular portions that need to be selected to provide the modular fixture 10 which includes the selected variables. That is, the modular system 10 allows for a relatively small number of portions that can be interconnected in a substantially large number of ways, that can be nearly infinite depending upon the number of modular portions to form the modular fixture 10, to include any of the selected variables.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A modular fixture for positioning a member to perform work on the member, the modular fixture comprising:
an arm to operably orient the member while work is performed on the member; and
a mid-plate to operably position said arm relative to a point;
wherein said arm extends from said mid-plate while work is performed on the member;
wherein said arm is selectively positionable relative to said mid-plate.

2. The modular fixture of claim 1, further comprising:
a riser that is adapted to be fixed to a surface;
wherein said arm is selectively positionable relative to said riser via the mid-plate.

3. The modular fixture of claim 1, further comprising:
a riser operable to be mounted to a surface;
wherein said mid-plate includes a riser mounting section and an accessory mounting section;
wherein said riser mounting section is adapted to be fixed relative to said riser.

4. The modular fixture of claim 3, wherein said accessory mounting section allows for positioning of an accessory relative to said arm.

5. The modular fixture of claim 1, wherein:
said mid-plate defines a plurality of arm attachment positions;
said arm is selectively positionable relative to said mid-plate through an interconnection with said arm attachment positions.

6. The modular fixture of claim 5, wherein:
said arm attachment positions include a plurality of bores;
said arm is interconnected with said mid-plate by operably connecting said arm with said bores.

7. The modular fixture of claim 1, wherein said arm includes:
a mid-plate positioning section; and
a member positioning section.

8. The modular fixture of claim 7, wherein said arm includes a plurality of arms;
wherein each of said plurality of arms includes a dimension different from each of the other plurality of said arms.

9. The modular fixture of claim 8, wherein said differing dimension includes a length of said member positioning section.

10. The modular fixture of claim 8, wherein said differing dimension includes a different number of positioning bores formed on said positioning section.

11. The mid-plate of claim 3, wherein said mid-plate includes a plurality of mid-plates;
wherein each of said plurality of mid-plates includes a different orientation of said accessory mounting section relative to said riser mounting section.

12. The modular fixture of claim 3, wherein said mid-plate includes a plurality of said mid-plates;
wherein each of said plurality of mid-plates includes bores defined by said accessory attachment section in at least one of a different orientation and a different position relative to said riser attachment section.

13. The modular fixture of claim 1, further comprising:
a positioning member to operably interconnect said arm and said mid-plate to allow for selectively positioning said arm relative to said mid-plate.

14. A modular portion of a fixture for positioning a member relative to a surface, the modular portion comprising:
a mounting plate selectively connectable to a portion of the fixture; and
an arm positionable relative to said mounting plate;
wherein said arm operably positions the member.

15. The modular portion of claim 14, wherein said mounting plate defines a plurality of arm attachment positions;
wherein said arm is positionable relative to said mounting plate by interconnection with said arm attachment positions.

16. The modular portion of claim 15, wherein each of said arm attachment positions is spaced a distance apart such that selectively positioning said arm between said arm attachment positions moves said arm a selected distance.

17. The modular portion of claim 15, wherein said mounting plate includes a riser attachment section and an accessory attachment section.

18. The modular portion of claim 17, wherein said mounting plate includes a plurality of said mounting plates;
wherein each of said plurality of mounting plates includes said accessory attachment section at a different position relative to said riser attachment section.

19. The modular portion of claim 17, wherein said mounting plate includes a plurality of said mounting plates;
wherein said accessory attachment section defines a plurality of bores;
wherein each of said plurality of mounting plates includes said bores positioned at a different orientation relative to said riser attachment section.

20. The modular portion of claim 14, wherein said arm includes a mounting plate attachment section and a member positioning section.

21. The modular portion of claim 20, wherein said arm includes a plurality of arms;
wherein each of said arms includes a different length of said member positioning section.

22. The modular portion of claim 20, wherein:
said arm includes a plurality of arms;
each of said plurality of arms includes a different number of positioning bores.

23. The modular portion of claim 17, further comprising:
an accessory including a postionable arm;
wherein said accessory is mounted to said accessory section of said mounting plate such that said positionable arm is positionable relative to said arm.

24. A method of providing a fixture including a plurality of modular portions to hold a member, the method comprises:
selecting a dimension at which to position the member;
selecting a first modular portion of the plurality of modular portions;
selecting a second modular portion of the plurality of modular portions; and
interconnecting said selected first modular portion and said selected second modular portion;
wherein said interconnected said selected first portion and said selected second portion substantially define said selected dimension.

25. The method of claim 24, wherein said selecting a first modular portion includes:
selecting said first modular portion to include a positioning section such that said selected second modular portion can be positioned relative to said selected first modular portion.

26. The method of claim 25, wherein selecting said positioning section includes providing a plurality of attachment positions with said first selected modular portion.

27. The method of claim 26, wherein said interconnecting said selected first portion with said selected second portion includes:
choosing one of said plurality of said attachment positions; and
fixing said selected second modular portion to said selected attachments positions.

28. The method of claim 24, wherein selecting a second modular portion includes selecting a length of a section of the second modular portion.

29. The method of claim 24, wherein selecting a second modular portion includes selecting a number of positioning bores formed in said second modular portion.

30. The method of claim 24, wherein-selecting a dimension includes:
selecting a height of the fixture;
selecting a gap of the fixture;
selecting a distance of said second modular portion;
selecting an angle of said first modular portion;
selecting an offset of said second modular portion; and
selecting a length of a portion of said second modular portion from said first modular portion.

31. The method of claim 24, wherein said second modular portion includes providing a plurality of attachment positions on said second modular portion;
wherein interconnecting said selected first modular portion and said second modular portion includes fixing said first modular portion with one of said plurality of attachment positions defined by said selected second modular portion.

32. A computer program for selecting a plurality of modules to be interconnected to hold a member, the program comprising:
inputting a selected dimension;
providing a look-up table including:
listing of a plurality of modules;
listing of a plurality of interconnections between said plurality of modules;
determining from said provided look-up table at least a first module and a second module from said list of plurality of modules;
determining from said look-up table at least one interconnection for said first module and said second module; and
outputting said determined-first module, second module, and said selected interconnection.

33. The computer program of claim 32, further comprising:
selecting a dimension such that said dimension positions the member in a selected position or orientation.

34. The computer program of claim 32, further comprising:
choosing said first module from said listing of a plurality of modules and selecting said second module from said listing of a plurality of modules;
determining a first difference between said selected dimension and a dimension produced by said first selected module and said second module;
selecting a third module from said listing of a plurality of modules and creating a second difference between a dimension created by said first module and said third module compared to said selected dimension; and
determining which of said first difference and said second difference is smaller.

35. The computer program of claim 34, wherein the smaller difference of said first difference and said second difference is retained.

36. The computer program of claim 32, further comprising:
minimizing a difference between a dimension provided by said determined first module, second module, and said selected interconnection and said inputted selected dimension;
wherein said output of said determined first module, second module, and said selected interconnection provides substantially no difference between a dimension formed by said determined first module, second module, and said selected interconnection and said input selected dimension.

37. The computer program of claim 32, wherein said listing of a plurality of modules includes a list of twenty modules.

38. The computer program of claim 37, wherein said twenty modules includes six of a first module, six of a second module, and eight of a third module.
